(19) United States
(12) Patent Application Publication
(10) Pub. No.: US 2007/0288522 A1
(43) Pub. Date: Dec. 13, 2007

(54) Information processing apparatus and recording medium

(76) Inventor: Fumihisa Kawashima, Kanagawa (JP)

Correspondence Address: DICKSTEIN SHAPIRO LLP, 1825 EYE STREET NW, Washington, DC, 20006-5403, US

(21) Appl. No.: 11/798,906

(22) Filed: May 17, 2007

(30) Foreign Application Priority Data
Jun. 7, 2006 (JP) 2006-158705

(51) Int. Cl. G06F 17/00

(52) U.S. Cl. 707/104.1

(57) ABSTRACT

A technology for converting input data into device-processable data that is processable by a device connected via a network is disclosed. A predetermined information item included in the input data and a predetermined position information item corresponding to the predetermined information item are held in advance in association with a predetermined process that is to be executed to process the input data. Plural information items and position information items corresponding to the information items are extracted from the input data. Control information that specifies a process to be executed to process the input data by the device based on the predetermined process is constructed in the event that the extracted information items and the extracted position information items include an information item and a position information item that respectively correspond to the predetermined information item and the predetermined position information item held in advance. The input data is converted into the device-processable data based on the constructed control information.

### BACKGROUND OF THE INVENTION

1. Field of the Invention

The present invention relates to an information processing apparatus to be connected to a device.

2. Description of the Related Art

There is a conventional technology of analyzing data created or viewed with an information processing apparatus such as a personal computer (PC) and executing a process specific to the data (hereinafter, “data-specific process”) on the data if the analysis results say that the data includes predetermined information. With this technology, if the data includes information specific to that data, a so-called forms overlay process can be executed to process the data, for example. Accordingly, processes for assorting various types of data can be performed efficiently.

For example, Japanese Laid-Open Patent Application No. 2005-284384 (Patent Document 1) discloses an image forming apparatus having a function based on the above-described technology.

Patent Document 1: Japanese Laid-Open Patent Application No. 2005-284384

However, with the conventional technology, depending on the information in the data output from an application, it may not be possible to execute an appropriate process on the data.

For example, when the data includes a plurality of the same predetermined information items, the same process is uniformly performed on each and every one of the information items. As a result, there may be cases where desirable process results cannot be attained.

Furthermore, depending on the type of application, the information in the data may be recognized as a character string or an image. Thus, there may be cases where it is not possible to apply the above-described technology of executing a data-specific process on the data including predetermined information.

### SUMMARY OF THE INVENTION

The present invention provides an information processing apparatus in which one or more of the above-described disadvantages are eliminated.

A preferred embodiment of the present invention provides an information processing apparatus and a recording medium with which data-specific processes can be executed to optimally process input data from various types of applications.

An embodiment of the present invention provides an information processing apparatus for converting input data into device-processable data that is processable by a device connected via a network, the information processing apparatus including a process setting registration unit configured to hold in advance therein a predetermined information item included in the input data and a predetermined position information item corresponding to the predetermined information item, the predetermined information item and the predetermined position information item being held in association with a predetermined process that is to be executed to process the input data; an information control unit configured to extract, from the input data, plural information items and position information items corresponding to the information items, and construct control information that specifies a process to be executed to process the input data by the device based on the predetermined process, wherein the control information is constructed in the event that the extracted information items and the extracted position information items include an information item and a position information item that respectively correspond to the predetermined information item and the predetermined position information item held by the process setting registration unit; and a data converting unit configured to convert the input data into the device-processable data based on the control information constructed by the information control unit.

An embodiment of the present invention provides an information processing apparatus for converting input data into device-processable data that is processable by a device connected via a network, the information processing apparatus including a process setting registration unit configured to hold in advance therein predetermined identification information for uniquely identifying the input data, the predetermined identification information being held in association with a predetermined process that is to be executed to process the input data; an information control unit configured to extract identification information from the input data, and construct control information that specifies a process to be executed to process the input data by the device based on the predetermined process, wherein the control information is constructed in the event that the extracted identification information corresponds to the predetermined identification information held by the process setting registration unit; and a data converting unit configured to convert the input data into the device-processable data based on the control information constructed by the information control unit.

An embodiment of the present invention provides a recording medium that stores therein a computer-readable program that causes a computer to execute a procedure for converting input data into device-processable data that is processable by a device connected via a network, the procedure including the steps of: (a) holding in advance a predetermined information item included in the input data and a predetermined position information item corresponding to the predetermined information item, the predetermined information item and the predetermined position information item being held in association with a predetermined process that is to be executed to process the input data; (b) extracting, from the input data, plural information items and position information items corresponding to the information items, and constructing control information that specifies a process to be executed to process the input data by the device based on the predetermined process, wherein the control information is constructed in the event that the extracted information items and the extracted position information items include an information item and a position information item that respectively correspond to the predetermined information item and the predetermined position information item held in advance; and (c) converting the input data into the device-processable data based on the constructed control information.

An embodiment of the present invention provides a recording medium that stores therein a computer-readable program that causes a computer to execute a procedure for converting input data into device-processable data that is processable by a device connected via a network, the procedure including the steps of: (a) holding in advance predetermined identification information for uniquely identifying the input data, the predetermined identification information being held in association with a predetermined process that is to be executed to process the input data; (b) extracting identification information from the input data, and constructing control information that specifies a process to be executed to process the input data by the device based on the predetermined process, wherein the control information is constructed in the event that the extracted identification information corresponds to the predetermined identification information held in advance; and (c) converting the input data into the device-processable data based on the constructed control information.

According to one embodiment of the present invention, an information processing apparatus and a recording medium are provided with which data-specific processes can be executed to optimally process input data from various types of applications.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram of a network configuration of an information processing system according to an embodiment of the present invention;

FIG. 2 is a block diagram of a hardware configuration of the information processing apparatus according to an embodiment of the present invention;

FIG. 3 is a functional block diagram of a hardware configuration of the information processing apparatus according to an embodiment of the present invention;

FIG. 4 is a block diagram of the printer driver and the data process setting unit shown in FIG. 3;

FIG. 5 is a flowchart of an operation performed by the information processing apparatus according to an embodiment of the present invention;

FIG. 6 is an example of the setting screen displayed by the detection information designating unit;

FIGS. 7A, 7B are examples of the setting screen displayed by the process content specifying unit;

FIG. 8 is a table of contents held in the process setting registration unit;

FIG. 9A is an example of data created by an application;

FIG. 9B is an example of data on which the data shown in FIG. 9A is to be overlaid;

FIG. 9C is an example of a printout result obtained by overlaying the data shown in FIG. 9A onto the data shown in FIG. 9B;

FIG. 9D is an example of data created by an application;

FIG. 9E is an example of a printout result obtained by overlaying the data shown in FIG. 9D onto the data shown in FIG. 9B;

FIG. 10A is an example of the structure of the intermediate data according to the first practical example;

FIG. 10B is an example of the structure of the intermediate data shown in FIG. 10A after being rewritten;

FIG. 11A is an example of the structure of the intermediate data according to the second practical example;

FIG. 11B is an example of the structure of the intermediate data shown in FIG. 11A after being rewritten;

FIG. 12A is an example of the structure of the intermediate data according to the third practical example; and

FIG. 12B is an example of the structure of the intermediate data shown in FIG. 12A after being rewritten.

### DETAILED DESCRIPTION OF THE PREFERRED EMBODIMENTS

A description is given, with reference to the accompanying drawings, of an embodiment of the present invention.

[Configuration]

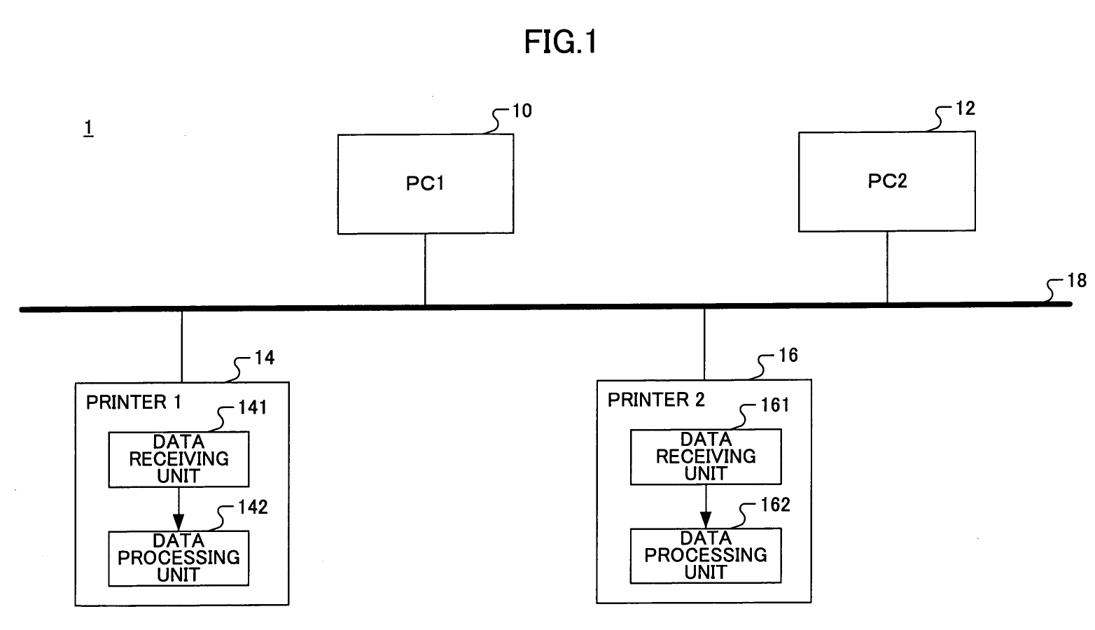

FIG. 1 is a block diagram of a network configuration of an information processing system according to an embodiment of the present invention.

An information processing system 1 includes information processing apparatuses 10 and 12 such as personal computers (PC), devices 14 and 16 such as printers, and a network 18 such as a local area network (LAN) that interconnects these elements so that data communications can be performed.

The PCs 10 and 12 have built-in applications that are programs that operate on an operating system (OS) such as Windows (registered trademark). The PCs 10 and 12 thus have functions of generating data with the applications.

The printers 14 and 16 are devices having print-out functions for printing out data generated by the applications in the PCs 10 and 12 onto paper. The printers 14 and 16 respectively include data receiving units 141 and 161 for receiving data from the PCs 10 and 12 and data processing units 142 and 162 for processing the received data.

The information processing system 1 shown in FIG. 1 is provided with two PCs and two printers; however, there can be more than two of each of these elements in practical implementations. Furthermore, devices other than PCs and printers can be included, as a matter of course.

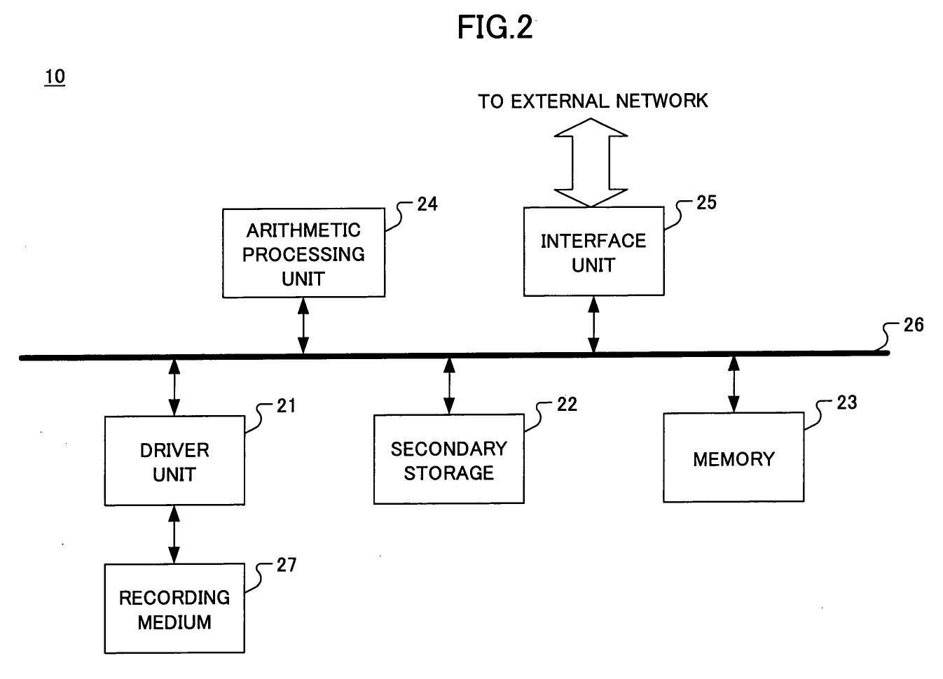

FIG. 2 is a block diagram of a hardware configuration of the information processing apparatus according to an embodiment of the present invention.

The information processing apparatus 10 shown in FIG. 2 includes a driver unit 21, a secondary storage 22, a memory 23, an arithmetic processing unit 24, and an interface unit 25, which are interconnected by a bus 26. Programs for realizing processes in the information processing apparatus 10 are provided by a recording medium 27 such as a CD-ROM.

The driver unit 21 is a unit for reading the recording medium 27. When the recording medium 27 having a program recorded therein is set in the driver unit 21, the program is installed in the secondary storage 22 from the recording medium 27 via the driver unit 21. In the present embodiment, a device driver typified by a printer driver described below is taken as an example of a program recorded in the recording medium.

The secondary storage 22 stores the installed program as well as necessary files and data.

The memory 23 reads the program from the secondary storage 22 and holds it therein when an instruction to activate the program is received.

The arithmetic processing unit 24 executes functions of the information processing apparatus 10 according to the program held in the memory 23.

The interface unit 25 connects the information processing apparatus 10 to an external network or a public line.

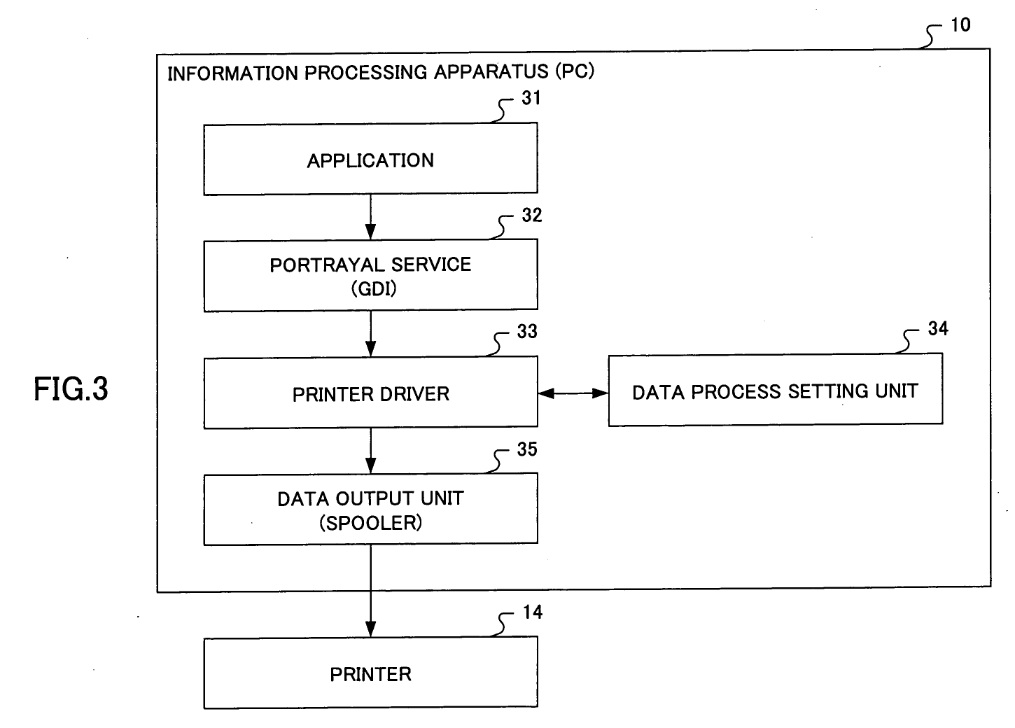

FIG. 3 is a functional block diagram of a hardware configuration of the information processing apparatus according to an embodiment of the present invention.

The information processing apparatus 10 shown in FIG. 3 includes an application 31, a portrayal service 32, a printer driver 33 that is an example of a device driver, a data process setting unit 34, and a data output unit 35, which are connected to the printer 14 via the network 18 as shown in FIG. 1.

The application 31 operates on an operating system (OS) such as Windows (registered trademark). For example, the application 31 is a general-purpose application such as document creating software or spreadsheet software.

The portrayal service 32 is a portrayal engine that operates on an operating system. The portrayal service 32 is generally included in a GDI (Graphic Device Interface) together with an interface for connecting the application 31 and the portrayal service 32.

The printer driver 33 is a data converting unit for converting an internal command in the OS into data that can be processed by the printer 14, i.e., into a so-called page description language (PDL). Generally, the GDI 32 and the printer driver 33 are connected by an interface called DDI (Device Driver Interface).

The data process setting unit 34 is a unit for generating a command to execute a data-specific process when the data output from the application 31 includes predetermined information.

The data output unit 35 is a so-called spooler, which is a module for spooling PDL data generated by the printer driver 33. Generally, the printer output speed is considerably low compared to the processing speed of the computer itself or the application. Accordingly, by using the spooler, the information processing apparatus 10 can be released from the printing process considerably faster compared to the case of directly sending the data to the printer, particularly when printing out large-sized data. The PDL data spooled by the spooler 35 is sent to the printer 14 from a printing port via the network 18.

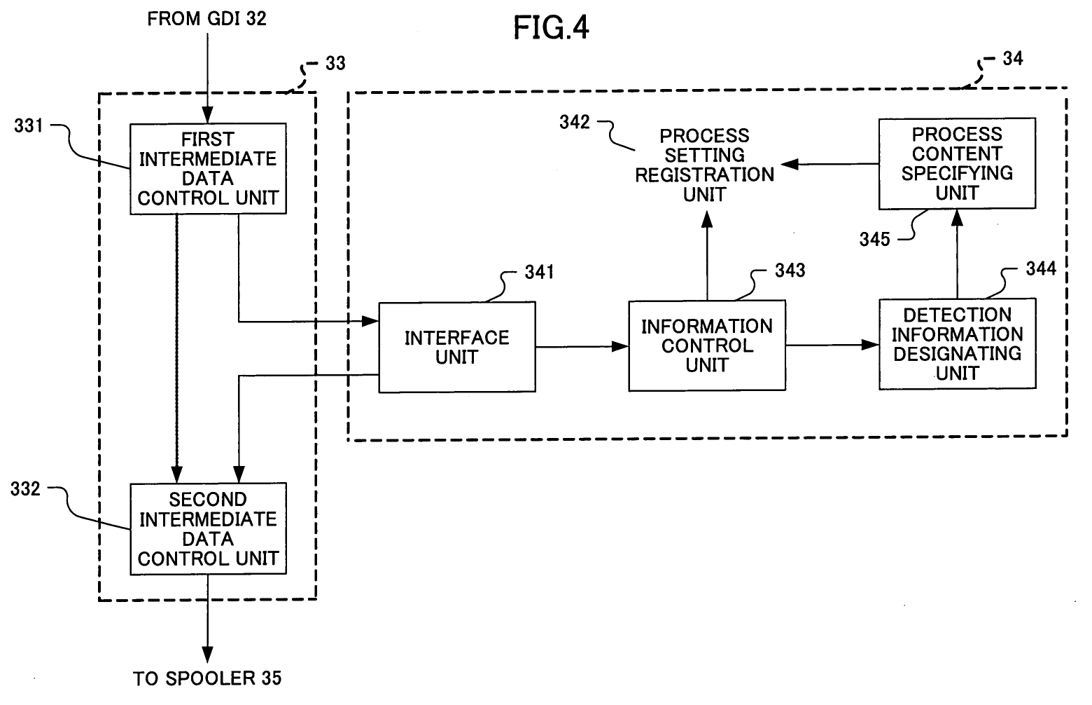

FIG. 4 is a block diagram of the printer driver 33 and the data process setting unit 34 shown in FIG. 3.

The printer driver 33 shown in FIG. 4 includes a first intermediate data control unit 331 and a second intermediate data control unit 332.

The first intermediate data control unit 331 is a unit for converting data received from the GDI 32 to intermediate data including control information and portrayal information, which intermediate data is in a format independent of the type of printer connected via the network 18. The second intermediate data control unit 332 is a unit for converting intermediate data into data that can be processed by a printer (hereinafter, “printer-processable data”) based on the control information.

The data process setting unit 34 shown in FIG. 4 includes an interface unit 341, a process setting registration unit 342, an information control unit 343, a detection information designating unit 344, and a process content specifying unit 345.

The interface unit 341 is an interface connecting the first intermediate data control unit 331 of the printer driver 33 and the information control unit 343.

The process setting registration unit 342 is a unit for registering predetermined information included in the intermediate data, which intermediate data is obtained as a result of the data conversion performed by the first intermediate data control unit 331. The predetermined information is registered in association with a predetermined process.

The information control unit 343 extracts plural information items from the intermediate data received from the first intermediate data control unit 331 via the interface unit 341. If the extracted information items include information corresponding to predetermined information registered beforehand in the process setting registration unit 342, the information control unit 343 constructs control information in the intermediate data. Specifically, the information control unit 343 constructs the control information so that the predetermined process registered in the process setting registration unit 342 is executed to process the input data from the application 31. In this example, “constructing” the control information means to perform at least one of adding data, changing (rewriting) data, and deleting data.

The detection information designating unit 344 is a unit for designating an information item from among the plural information items extracted by the information control unit 343 as predetermined information to be registered in the process setting registration unit 342. The detection information designating unit 344 displays a setting screen on a display device (not shown) such as a monitor so that a user can select/designate a predetermined information item.

The process content specifying unit 345 is a unit for associating predetermined process content with the predetermined information designated at the detection information designating unit 344. The process content specifying unit 345 displays a setting screen on the display device such as a monitor so that a user can specify predetermined process content.

[Operation]

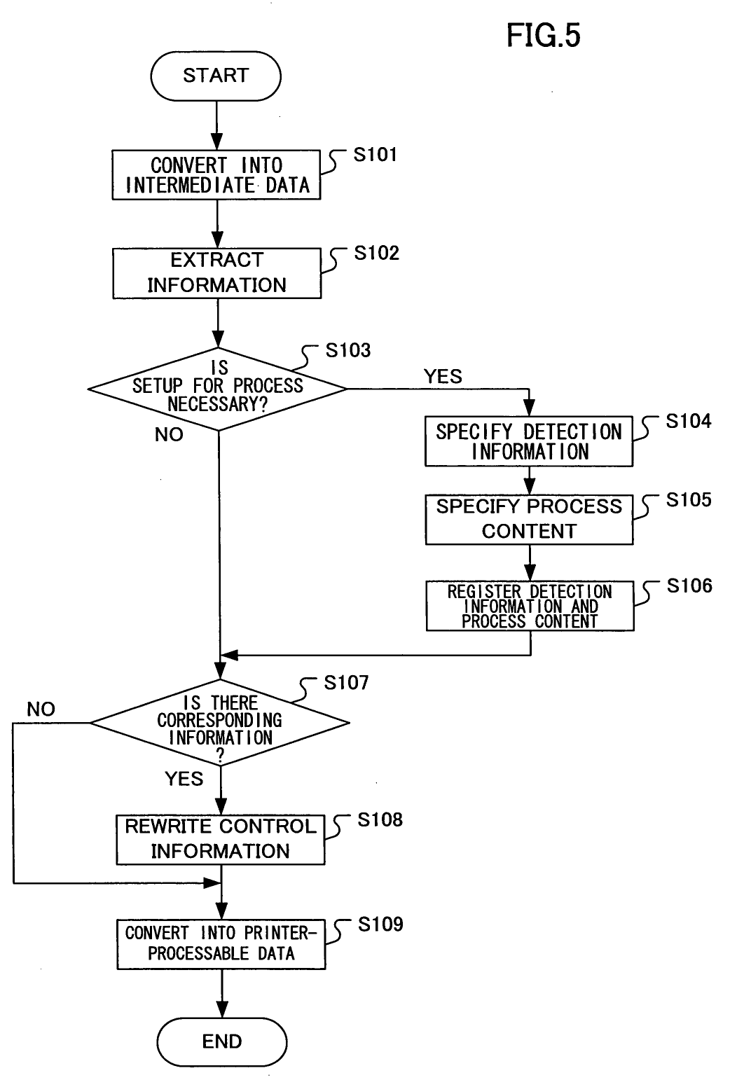

FIG. 5 is a flowchart of an operation performed by the information processing apparatus according to an embodiment of the present invention.

Referring to FIG. 3, when data created at the application 31 is input to the printer driver 33 via the GDI 32, in step S101, the first intermediate data control unit 331 of the printer driver 33 shown in FIG. 4 converts the input data from the application 31 into intermediate data including control information and portrayal information. This intermediate data is sent to the information control unit 343 via the interface unit 341.

In step S102, the information control unit 343 extracts plural information items included in the intermediate data. The information items extracted by the information control unit 343 include, for example, character strings and images included in the portrayal information of the intermediate data, the position information of such character strings and images, and identification information for uniquely identifying input data included in the control information.

In step S103, in a case where a setup needs to be specified to execute a data-specific process on input data from the application 31, the plural information items extracted by the information control unit 343 are sent to the detection information designating unit 344.

In step S104, the detection information designating unit 344 displays a setting screen on the display device such as the monitor so that a user can select/designate a particular information item that is to be detected (detection information) from among the plural information items extracted by the information control unit 343. The user specifies the detection information by following instructions displayed on the setting screen.

In step S105, the process content specifying unit 345 displays a setting screen on the display device such as the monitor so that a user can specify contents of a process to be executed to process input data from the application 31. The user specifies a process corresponding to the detection information specified at the detection information designating unit 344.

The detection information and the process content specified in the above steps are associated with each other and registered in the process setting registration unit 342 in step S106.

When the detection information and the process content are registered in the process setting registration unit 342, or when there already are predetermined detection information and predetermined process content registered beforehand in the process setting registration unit 342 so that there is no need to specify a setup to execute a data-specific process on input data from the application 31 in step S103, the following step S107 is performed. That is, in step S107, the information control unit 343 determines whether the information items extracted from the intermediate data at step S102 include information that corresponds to the detection information registered in the process setting registration unit 342.

When the information control unit 343 detects information that corresponds to the detection information, in step S108, the information control unit 343 rewrites the control information of the intermediate data based on the predetermined process content registered in the process setting registration unit 342 in association with that particular detection information. Then, the intermediate data is sent to the second intermediate data control unit 332 of the printer driver 33.

When the information control unit 343 does not detect information that corresponds to the detection information in step S107, the intermediate data is unchanged and sent to the second intermediate data control unit 332.

Last, in step S109, the second intermediate data control unit 332 converts the intermediate data into printer-processable data, according to the control information included in the intermediate data.

In a case where a setup is not specified for the input data from the application 31 for the above-described process, the intermediate data generated by the conversion operation of the first intermediate data control unit 331 can be directly sent to the second intermediate data control unit 332 inside the same printer driver 33 without going through the data process setting unit 34.

[Specification of Detection Information and Process Content]

A detailed description of the above-described operation of specifying the detection information and process content is given below.

From the intermediate data generated by converting the input data from the application 31, the information control unit 343 shown in FIG. 4 extracts information items such as character strings, the position information of such character strings, and identification information for uniquely identifying input data such as a job name.

The detection information designating unit 344 displays a list of the information items extracted by the information control unit 343 on the setting screen.

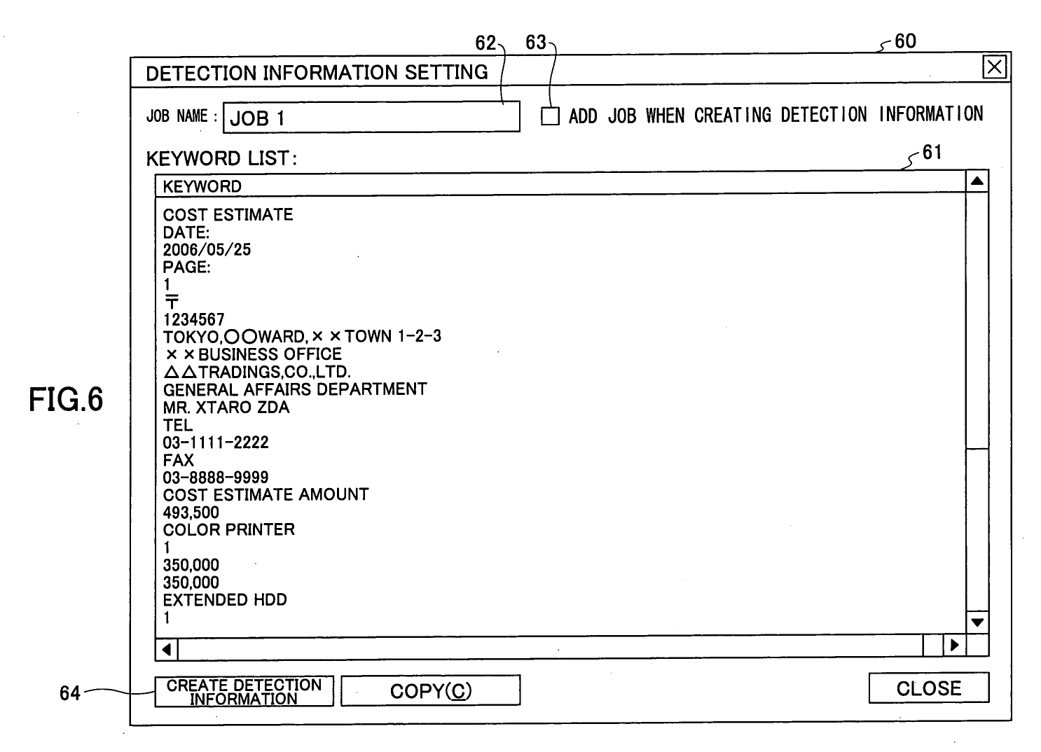

FIG. 6 is an example of the setting screen displayed by the detection information designating unit 344.

In the present embodiment, a detection information setting screen 60 shown in FIG. 6 displays a list 61 of character strings, which are examples of the information items extracted by the information control unit 343, and displays a job name in a display field 62. The user uses an input unit (not shown) such as a mouse and a keyboard to directly select a particular character string to be specified as detection information from the list 61 shown in the detection information setting screen 60. Although not shown in the list 61, the position information of the selected character string can also be specified. Furthermore, as shown in FIG. 6, the detection information setting screen 60 can also include a check box 63 so that the user can also specify the job name displayed in the display field 62 as detection information in addition to the character string. By ticking the check box 63, the user can also add the job name to the detection information. Finally, when the user presses a button 64, specification of the detection information is completed.

After the detection information is specified, the process content specifying unit 345 shown in FIG. 4 displays a setting screen for the user to specify contents of a process to be executed to process the input data from the application 31.

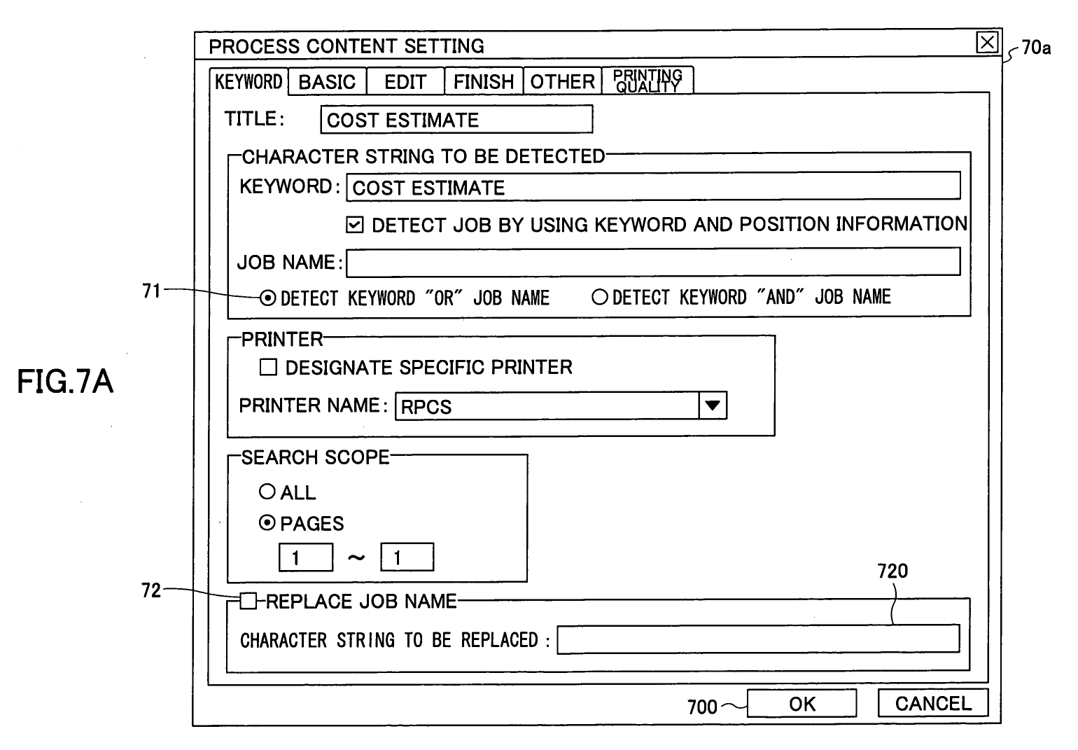

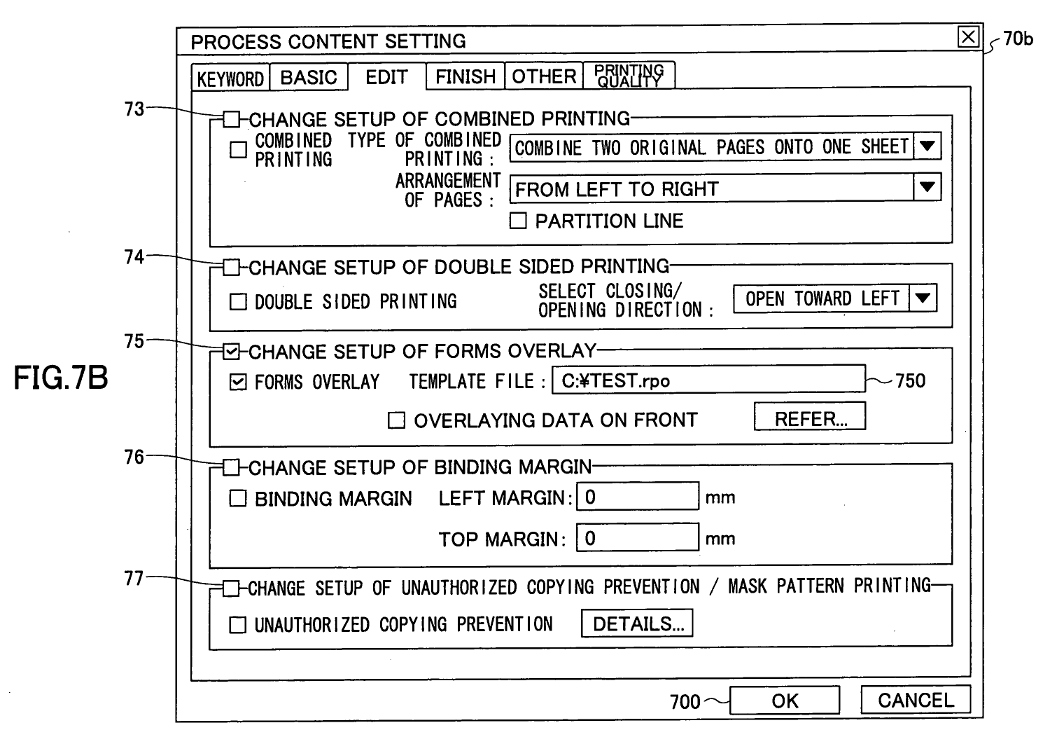

FIGS. 7A, 7B are examples of the setting screen displayed by the process content specifying unit 345.

In a first process content setting screen 70a shown in FIG. 7A, the user uses the input unit such as a mouse and a keyboard to select a selection button 71. Accordingly, the user can select whether to use either one of a character string or a job name as the actual detection information, or to use both of these as the actual detection information (hereinafter, “detection condition”). As shown in FIG. 7A, the first process content setting screen 70a can further include a check box 72 and an input field 720 for inputting a changed job name. For example, when data is created by an application that assigns the same job name to all created data, the job name of each data item can be changed so that the data items can be distinguishable from one another.

Next, in a second process content setting screen 70b shown in FIG. 7B, the user specifies the contents of a process to be executed to process the input data from the application 31. For example, as shown in FIG. 7B, the second process content setting screen 70b can include setup items 73-77 for specifying a printing process such as combined printing, double-sided printing, forms overlay, binding margin printing, mask pattern printing, etc.

For example, in order to specify forms overlay printing in the second process content setting screen 70b, the user ticks the setup item 75 and inputs in an input field 750 a file name or an address of a template file on which the printout is to be overlaid.

After the process is specified, the user presses a button 700, so that the detection information and the process are associated with each other and loaded in the process setting registration unit 342 shown in FIG. 4.

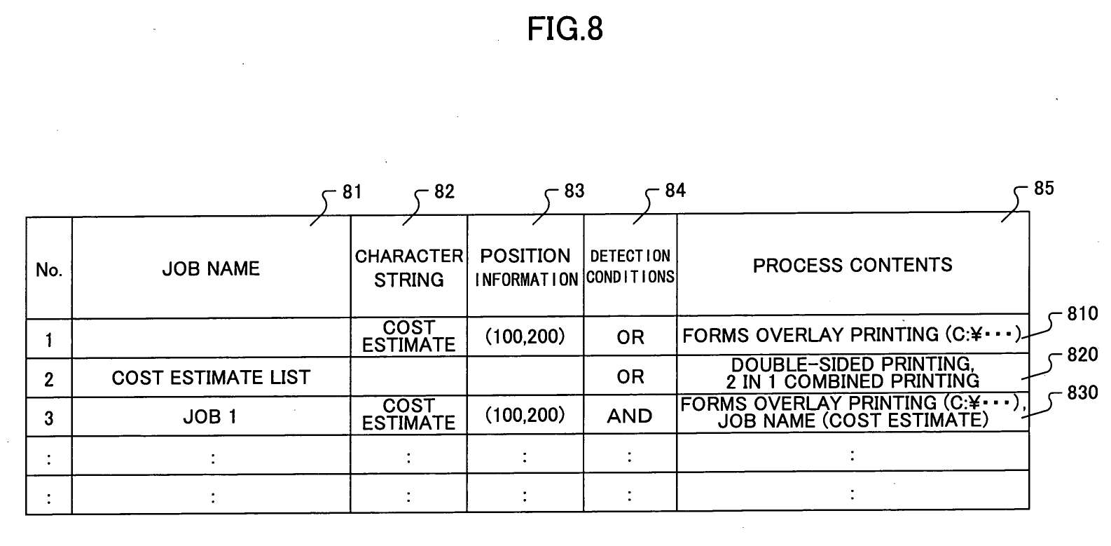

FIG. 8 is a table of contents held in the process setting registration unit 342.

The table shown in FIG. 8 is includes detection information specified at the detection information designating unit 344 such as a job name 81, a character string 82, and position information (coordinates) 83 of the character string, detection conditions 84, and process contents 85 specified at the process content specifying unit 345. In the present embodiment, the position information 83 of the character string is expressed by coordinates in the input data from the application 31; however, the position information 83 of the character string can be expressed by other types of information. In the present embodiment, information items associated with each other are held on the same line in corresponding fields.

As described above, in the information processing apparatus according to the present embodiment, input data from the application is converted into intermediate data, and predetermined information included in the intermediate data acts as a condition for executing a process. Accordingly, it is possible to execute a data-specific process on the input data from an application, regardless of the type of application.

Practical examples of the present invention are described below.

### FIRST PRACTICAL EXAMPLE

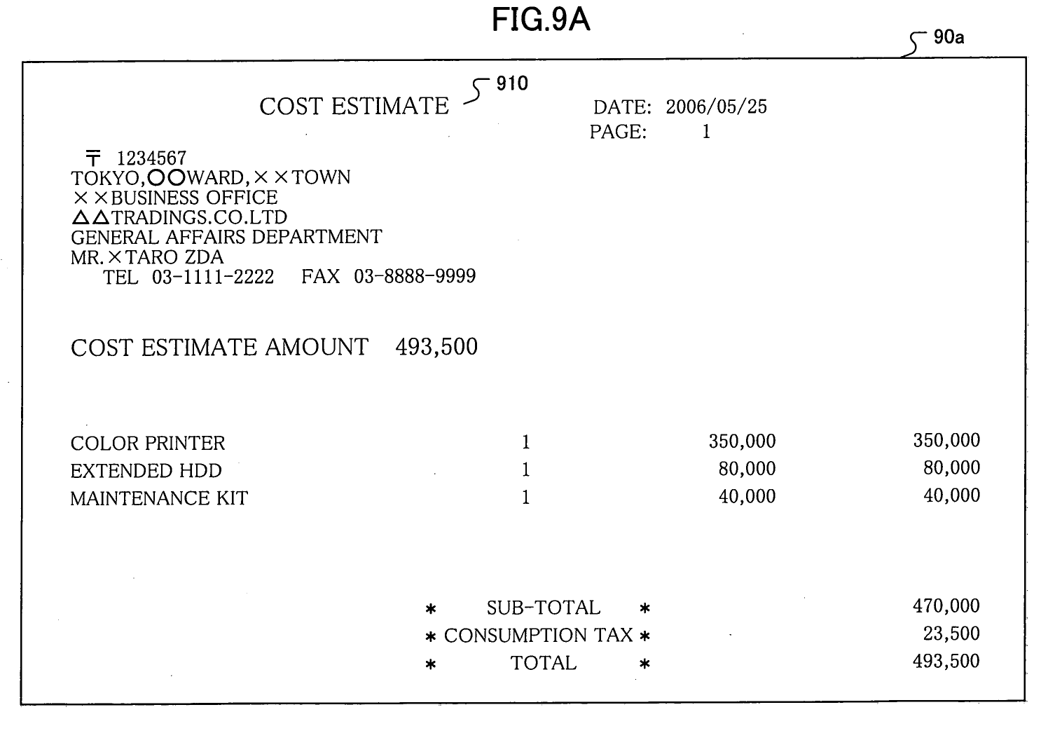

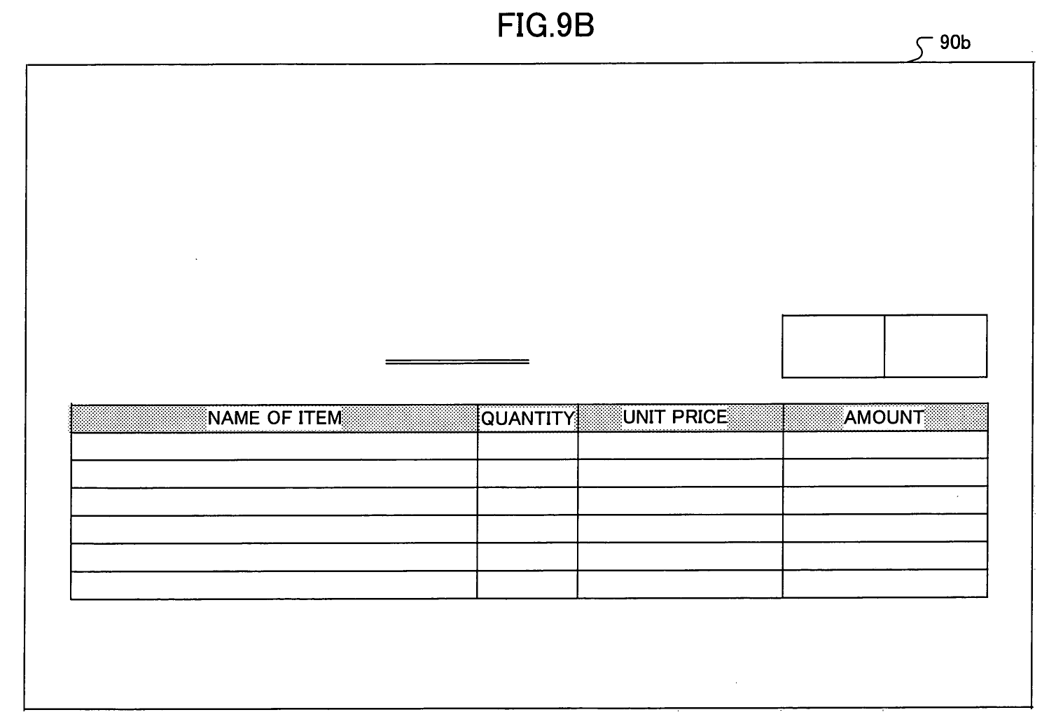

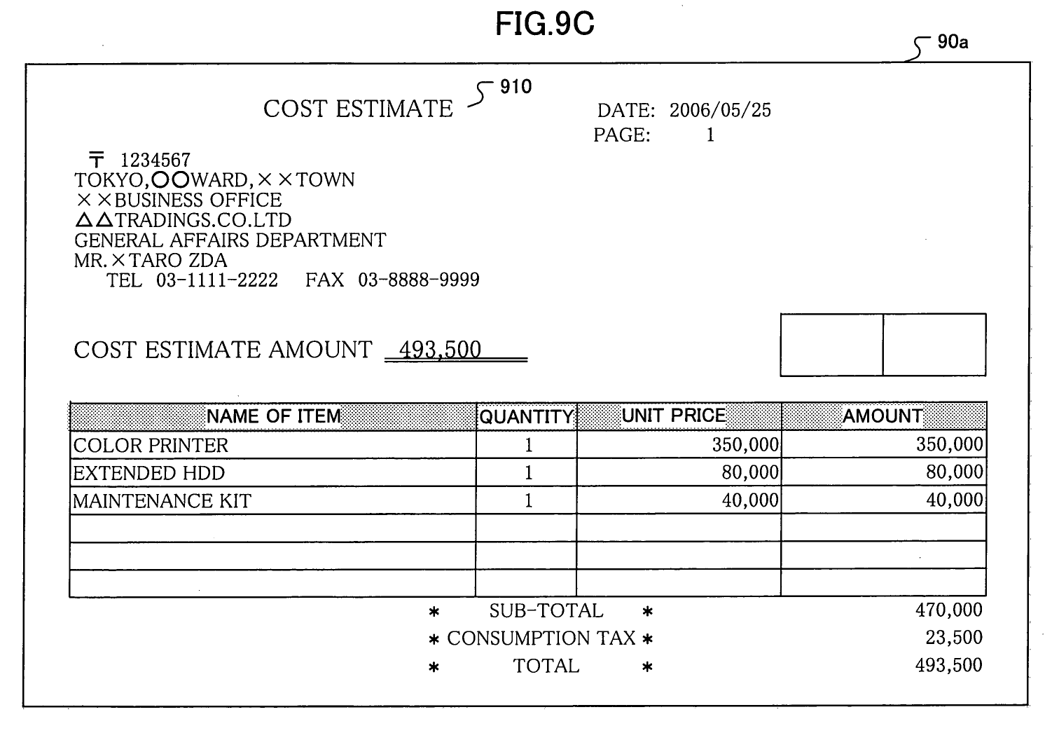

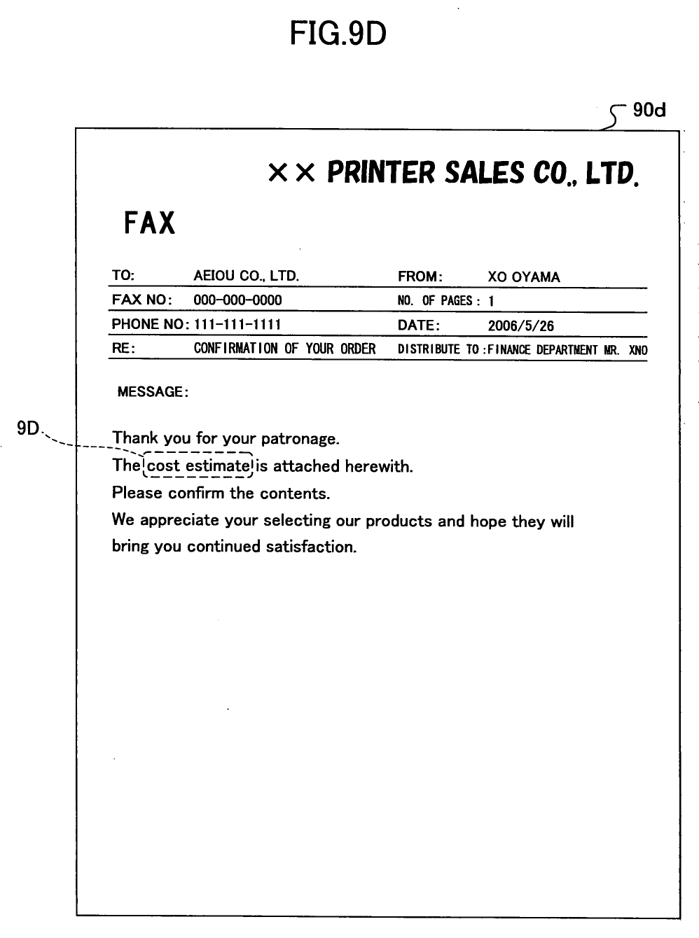

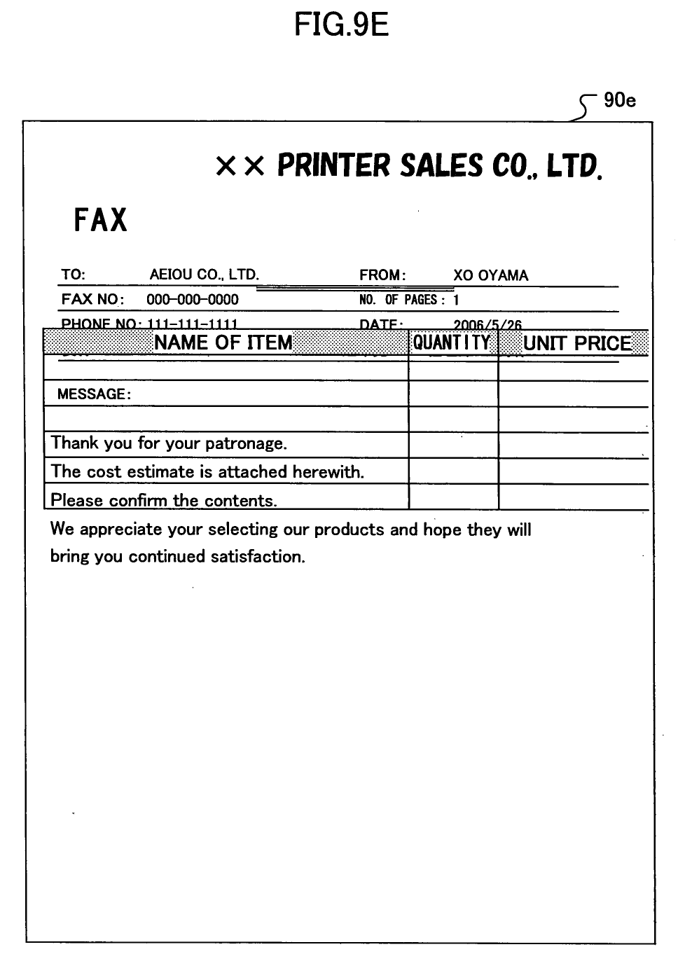

For example, input data 90a shown in FIG. 9A created with an application is overlaid onto template input data 90b shown in FIG. 9B. Accordingly, a printout result 90c shown in FIG. 9C is output from the printer. In this example, the input data 90a only includes character strings. The template input data 90b is a form or layout data stored in the secondary storage 22 shown in FIG. 2 or an external storage.

Referring to FIG. 3, the input data 90a created with the application 31 is input to the printer driver 33 via the GDI 32.

Next, referring to FIG. 4, the input data 90a from the application 31 is converted into intermediate data by the first intermediate data control unit 331 of the printer driver 33.

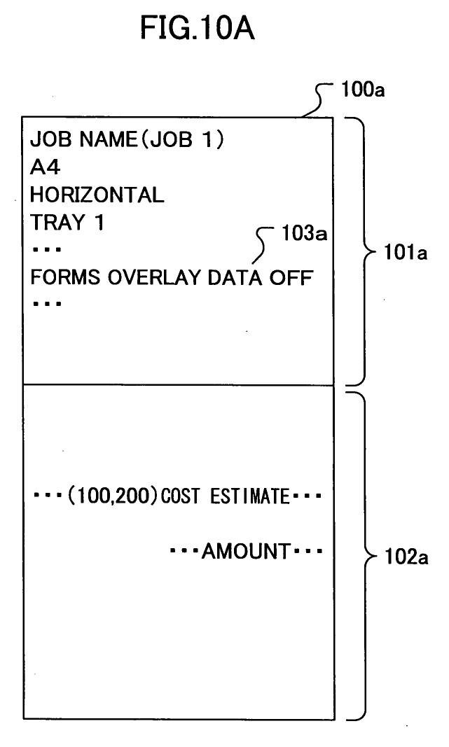

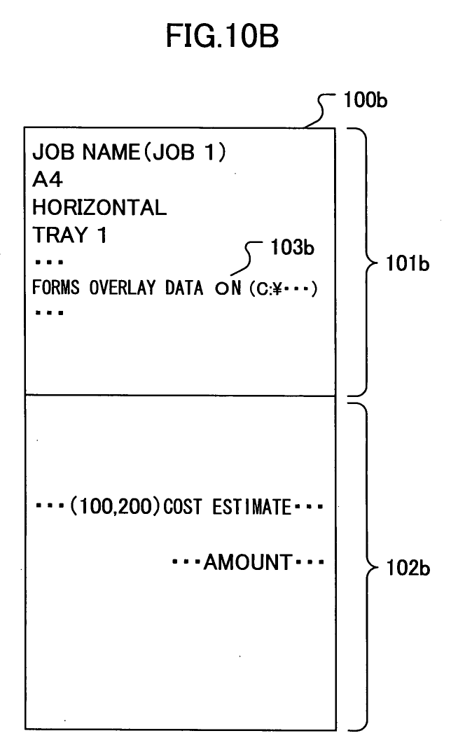

FIG. 10A is an example of the structure of the intermediate data according to the first practical example. Intermediate data 100a includes control information 101a and portrayal information 102a. The control information 101a includes identification information such as a job name for uniquely identifying the input data 90a received from the application 31, the sheet size, the print orientation, and a process content such as forms overlay that is to be executed to process the input data. The portrayal information 102a includes character strings included in the input data 90a and position information of each of the character strings. If the input data 90a includes images, the portrayal information 102a includes images and position information of each of the images. In the first practical example, the control information 101a includes a forms overlay printing command 103a; however, it is assumed that the forms overlay printing command 103a is turned off at the point when the input data 90a is converted into intermediate data.

After the first intermediate data control unit 331 converts the input data 90a into the intermediate data 100a, the intermediate data 100a is sent to the data process setting unit 34. In the data process setting unit 34, the intermediate data 100a is sent to the information control unit 343 via the interface unit 341.

The information control unit 343 extracts the character strings and position information of each of the character strings from the portrayal information 102a of the intermediate data 100a. In a case where a setup needs to be specified to execute a data-specific process on the input data 90a, the extracted character strings and position information are sent to the detection information designating unit 344.

The detection information designating unit 344 displays the detection information setting screen 60 shown in FIG. 6 on the display device such as the monitor based on the character strings extracted by the information control unit 343. For example, the user selects a character string from the list 61 of the detection information setting screen 60 corresponding to a character string 910 “Cost Estimate” included in the input data 90a shown in FIG. 9A. The selected character string “Cost Estimate” and its position information are sent to the process content specifying unit 345.

The process content specifying unit 345 displays the first process content setting screen 70a and the second process content setting screen 70b shown in FIGS. 7A and 7B, respectively, on the display device such as the monitor. For example, in the first process content setting screen 70a shown in FIG. 7A, the user specifies a setup with the selection button 71 so that only the character string “Cost Estimate” is used as the detection information. Furthermore, the user ticks the setup item 75 in the second process content setting screen 70b to specify forms overlay printing for the input data 90a shown in FIG. 9A, and inputs in the input field 750 a file name or an address of the template input data 90b on which the input data 90a is to be overlaid. The setup of the forms overlay printing is registered in the process setting registration unit 342 in association with the character string “Cost Estimate” selected in the detection information setting screen 60 and the corresponding position information.

In the first practical example, assuming that the contents registered in the process setting registration unit 342 are expressed in a table format as shown in FIG. 8, the contents are held in a line 810 in the table as follows: the character string “Cost Estimate” is held in the field of the character string 82; coordinates (100, 200) of the character string “Cost Estimate” in the input data 90a shown in FIG. 9A are held as position information of the character string “Cost Estimate” in the field of the position information 83; data “OR” indicating that only a character string is to be used as the actual detection information is held in the field of the detection conditions 84; and a specification of forms overlay printing is held in the field of the process contents 85 together with the file name of the template input data 90b shown in FIG. 9B on which the input data is to be overlaid. Furthermore, in the first practical example, identification information of the input data 90a is not extracted, and therefore, data pertaining to a job name is not held in the field of the job name 81.

If the process setting registration unit 342 holds a character string, the corresponding position information, and a process content, the information control unit 343 determines whether character strings extracted from the intermediate data include a character string that corresponds to the character string “Cost Estimate” registered in the process setting registration unit 342. If a corresponding character string is detected, and further, if the position information of the character strings are the same, the information control unit 343 rewrites the control information 101a in the intermediate data 100a shown in FIG. 10A based on the setup of the forms overlay printing registered in association with the character string “Cost Estimate” in the process setting registration unit 342.

FIG. 10B is an example of the structure of the intermediate data after being rewritten. Intermediate data 100b shown in FIG. 10B includes control information 101b and portrayal information 102b, as in the status before being rewritten. In the first practical example, a forms overlay printing command 103b in the control information 101b is turned on from the off status. Furthermore, a link to a file of the template data is provided. Meanwhile, the portrayal information 102b remains unchanged from the portrayal information 102a before being rewritten. Subsequently, the intermediate data 100b is sent to the second intermediate data control unit 332 of the printer driver 33.

The second intermediate data control unit 332 converts the intermediate data 100b, according to the control information 101b of the intermediate data 100b, into printer-processable data. Based on this converted data, the printer overlays the input data 90a shown in FIG. 9A input from the application 31 on the template input data 90b shown in FIG. 9B, thus obtaining the printout result 90c shown in FIG. 9C.

If the position information of the character string were not registered as detection information in the process setting registration unit 342, the following problem would arise. That is, if FAX transmission data 90d shown in FIG. 9D created by an application includes a character string “Cost Estimate” 920 that is the same as that of the detection information registered beforehand in the process setting registration unit 342, the above-described forms overlay printing process is automatically executed to process the FAX transmission data 90d, even if it is unintended by the user. In such a case, a printout result 90e shown in FIG. 9E is output from the printer.

As described above, in the information processing apparatus according to the first practical example, conditions for executing a predetermined process on input data from an application include not only information such as character strings or images but also the position information of such information in the input data. Therefore, even if plural copies of the same information are included in the input data or in different data, it is possible to identify the correct predetermined information corresponding to the condition for executing the process, from among the plural copies of the same information. Accordingly, it is possible to execute a data-specific process on the input data from an application regardless of the type of application, and with improved accuracy.

### SECOND PRACTICAL EXAMPLE

In a second practical example, a setup is specified so as to perform combined printing and double-sided printing with the input data 90a shown in FIG. 9A. Furthermore, the input data 90a is assumed to have a job name “Cost Estimate List” as identification information for uniquely identifying the input data 90a.

Referring to FIG. 3, the input data 90a created by the application 31 is input to the printer driver 33 via the GDI 32.

Next, referring to FIG. 4, the input data 90a from the application 31 is converted into intermediate data by the first intermediate data control unit 331 of the printer driver 33.

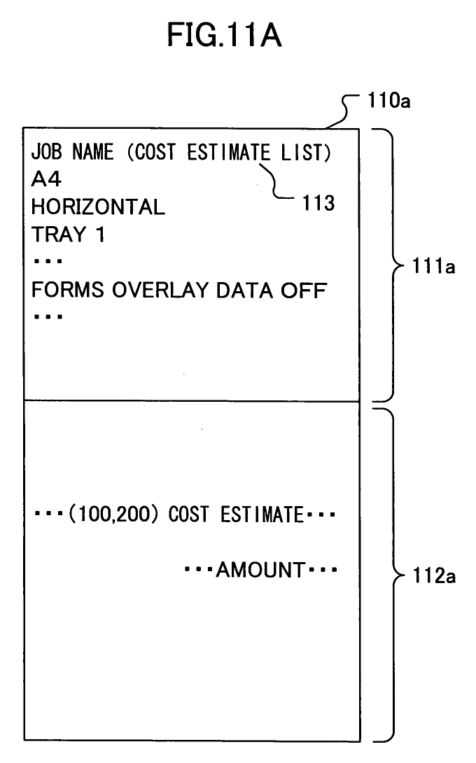

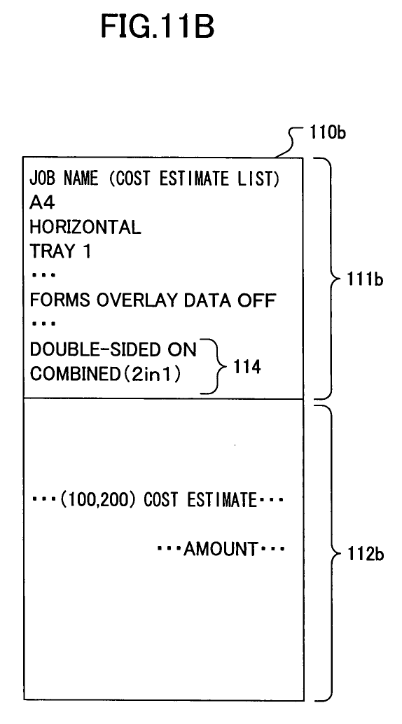

FIG. 11A is an example of the structure of the intermediate data according to the second practical example. Intermediate data 110a shown in FIG. 11A includes control information 111a and portrayal information 112a. The control information 111a includes identification information for uniquely identifying the input data 90a received from the application 31, which identification information is a job name “Cost Estimate List” 113 in the second practical example, the sheet size, the print orientation, and process contents such as combined printing and double-sided printing that are to be executed to process the input data. The portrayal information 112a includes character strings included in the input data 90a and position information of each of the character strings. If the input data 90a includes images, the portrayal information 112a includes images and position information of each of the images.

After the first intermediate data control unit 331 converts the input data 90a into the intermediate data 110a, the intermediate data 110a is sent to the data process setting unit 34. In the data process setting unit 34, the intermediate data 110a is sent to the information control unit 343 via the interface unit 341.

The information control unit 343 extracts the job name “Cost Estimate List” 113 included in the control information 111a of the intermediate data 110a. In a case where a setup needs to be specified to execute a data-specific process on the input data 90a, the extracted job name is sent to the detection information designating unit 344.

The detection information designating unit 344 displays the detection information setting screen 60 shown in FIG. 6 on the display device such as the monitor based on the job name extracted by the information control unit 343. For example, the user ticks the check box 63 so that the job name “Cost Estimate List” of the input data 90a shown in FIG. 9A is specified as the detection information. The job name “Cost Estimate List” specified as the detection information is sent to the process content specifying unit 345. In the second practical example, when the list 61 of character strings is displayed as in the detection information setting screen 60 shown in FIG. 6, one or plural character strings can be specified from the list 61, in addition to the job name.

The process content specifying unit 345 displays the first process content setting screen 70a and the second process content setting screen 70b shown in FIGS. 7A and 7B, respectively, on the display device such as the monitor. For example, in the first process content setting screen 70a shown in FIG. 7A, the user specifies a setup with the selection button 71 so that only the job name “Cost Estimate List” is used as the detection information. Furthermore, the user ticks the setup items 73 and 74 in the second process content setting screen 70b to specify combined printing and double-sided printing, and specifies details such as the type of combined printing. Setups for combined printing and double-sided printing are registered in the process setting registration unit 342 in association with the job name “Cost Estimate List” specified as the detection information in the detection information setting screen 60.

In the second practical example, assuming that the contents registered in the process setting registration unit 342 are expressed in the table format as shown in FIG. 8, the contents are held in a line 820 in the table as follows: the job name “Cost Estimate List” is held in the field of the job name 81; data “OR” indicating that only the job name is to be used as the actual detection information is held in the field of the detection conditions 84; and specifications of combined printing and double-sided printing are held in the field of the process contents 85 together with detailed setups thereof such as “2 in 1”, i.e., combining data corresponding to two original pages onto one sheet. Furthermore, in the second practical example, character strings and corresponding position information are not extracted from the input data 90a, and therefore, data pertaining to character strings and position information is not held in the fields of the character string 82 and the position information 83.

If the process setting registration unit 342 holds a job name and a process content, the information control unit 343 determines whether the job name extracted from the intermediate data corresponds to the job name “Cost Estimate List” registered in the process setting registration unit 342. If the job names are the same, the information control unit 343 rewrites the control information 111a in the intermediate data 110a shown in FIG. 11A based on the setups of combined printing and double-sided printing registered in association with the job name “Cost Estimate List” in the process setting registration unit 342.

FIG. 11B is an example of the structure of the intermediate data after being rewritten. Intermediate data 110b shown in FIG. 11B includes control information 111b and portrayal information 112b, as in the status before being rewritten. In the second practical example, the control information 111a is rewritten by adding a double-sided printing and combined printing command 114 so as to obtain the control information 111b. Meanwhile, the portrayal information 112b remains unchanged from the portrayal information 112a before being rewritten. Subsequently, the intermediate data 10b is sent to the second intermediate data control unit 332 of the printer driver 33.

The second intermediate data control unit 332 converts the intermediate data 10b into printer-processable data, according to the control information 111b of the intermediate data 110b. Based on this converted data, the printer combines the input data 90a shown in FIG. 9A received from the application 31 (i.e., combines plural pages onto one page) and prints them out on both sides of sheets.

As described above, in the information processing apparatus according to the second practical example, identification information such as a job name for uniquely identifying input data from an application is specified as the condition for executing a predetermined process on input data from an application. Therefore, the same process can be uniformly executed to process different sets of data including predetermined identification information.

### THIRD PRACTICAL EXAMPLE

Similarly to the first practical example, the input data 90a shown in FIG. 9A created with an application is overlaid onto the template input data 90b shown in FIG. 9B so that the printout result 90c shown in FIG. 9C is output from the printer. It is assumed that the input data 90a is created by an application that assigns the same job name to all sets of data created therein.

Referring to FIG. 3, the input data 90a created with the application 31 is input to the printer driver 33 via the GDI 32.

Next, referring to FIG. 4, the input data 90a from the application 31 is converted into intermediate data by the first intermediate data control unit 331 of the printer driver 33.

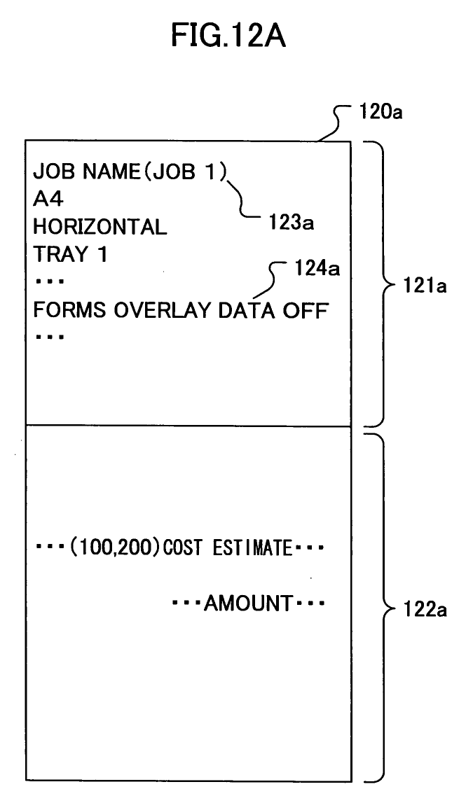

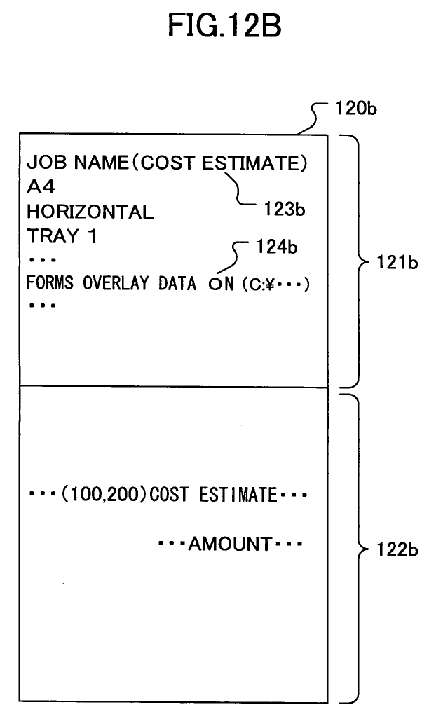

FIG. 12A is an example of the structure of the intermediate data according to the third practical example. Intermediate data 120a shown in FIG. 12A includes control information 121a and portrayal information 122a. The control information 121a includes identification information for uniquely identifying the input data 90a from the application 31, which identification information is a job name “Job 1” 123a in the third practical example, the sheet size, the print orientation, and a process content such as forms overlay that is to be executed to process the input data. The portrayal information 122a includes character strings included in the input data 90a and position information of each of the character strings. If the input data 90a includes images, the portrayal information 122a includes images and position information of each of the images. In the third practical example, the control information 121a includes a forms overlay printing command 124a; however, it is assumed that the forms overlay printing command 124a is turned off at the point when the input data 90a is converted into intermediate data.

After the first intermediate data control unit 331 converts the input data 90a into the intermediate data 120a, the intermediate data 120a is sent to the data process setting unit 34. In the data process setting unit 34, the intermediate data 120a is sent to the information control unit 343 via the interface unit 341.

The information control unit 343 extracts the job name “Job 1” 123a from the control information 121a of the intermediate data 120a and also extracts the character strings and position information of each of the character strings from the portrayal information 122a of the intermediate data 120a. In a case where a setup needs to be specified to execute a data-specific process on the input data 90a, the extracted job name, character strings, and position information are sent to the detection information designating unit 344.

The detection information designating unit 344 displays the detection information setting screen 60 shown in FIG. 6 on the display device such as the monitor based on the job name and the character strings extracted by the information control unit 343. For example, the user selects a character string from the list 61 of the detection information setting screen 60 corresponding to the character string 910 “Cost Estimate” included in the input data 90a shown in FIG. 9A. Furthermore, the user ticks the check box 63 so that the job name “Job 1” displayed in the display field 62 is also specified as detection information. The character string “Cost Estimate”, the corresponding position information, and the job name “Job 1” specified as the detection information are sent to the process content specifying unit 345.

The process content specifying unit 345 displays the first process content setting screen 70a and the second process content setting screen 70b shown in FIGS. 7A and 7B, respectively, on the display device such as the monitor. For example, in the first process content setting screen 70a shown in FIG. 7A, the user specifies a setup with the selection button 71 so that both the character string “Cost Estimate” and the job name “Job 1” are used as the detection information. Furthermore, the user ticks the setup item 72 to change the job name “Job 1” so that the input data 90a can be distinguished from other data created by the same application 31, and inputs a job name “Cost Estimate” in the input field 720 as the new job name. Furthermore, the user ticks the setup item 75 in the second process content setting screen 70b shown in FIG. 7B to specify forms overlay printing for the input data 90a shown in FIG. 9A, and inputs in the input field 750 a file name or an address of the template input data 90b shown in FIG. 9B on which the input data 90a is to be overlaid. The setups for the job name changing process and the forms overlay printing are registered in the process setting registration unit 342 in association with the character string “Cost Estimate” selected in the detection information setting screen 60 and the corresponding position information.

In the third practical example, assuming that the contents registered in the process setting registration unit 342 are expressed in a table format as shown in FIG. 8, the contents are held in a line 830 in the table as follows: the job name “Job 1” is held in the field of the job name 81; the character string “Cost Estimate” is held in the field of the character string 82; coordinates (100, 200) of the character string “Cost Estimate” in the input data 90a shown in FIG. 9A are held as position information of the character string “Cost Estimate” in the field of the position information 83; data “AND” indicating that both a character string and a job name are to be used as the detection information is held in the field of the detection conditions 84; and specifications of the job name changing process and forms overlay printing are held in the field of the process contents 85 together with the file name of the template input data 90b shown in FIG. 9B on which the input data is to be overlaid.

As described above, when detection information, which is a combination of a character string, the position information thereof, and a job name, and a process content are registered in the process setting registration unit 342, the information control unit 343 determines whether a job name extracted from intermediate data corresponds to the job name “Job 1” registered in the process setting registration unit 342. When the job names are the same, the information control unit 343 further determines whether character strings extracted from the intermediate data include a character string that corresponds to the character string “Cost Estimate” registered in the process setting registration unit 342 in association with the job name “Job 1”. If a corresponding character string is detected, and further, if the position information of the character strings are the same, the information control unit 343 rewrites the control information 121a in the intermediate data 120a shown in FIG. 12A based on the setups of the job name changing process and the forms overlay printing registered in association with the job name “Job 1” and the character string “Cost Estimate” in the process setting registration unit 342.

FIG. 12B is an example of the structure of the intermediate data after being rewritten. Intermediate data 120b shown in FIG. 12B includes control information 121b and portrayal information 122b, as in the status before being rewritten. In the third practical example, the control information 121a is rewritten to be the control information 121b. Specifically, the job name is changed from “Job 1” to a job name 123b “Cost Estimate”, a forms overlay printing command 124b is turned on from the off status, and a link to a file of the template data is provided. Meanwhile, the portrayal information 122b remains unchanged from the portrayal information 122a before being rewritten. Subsequently, the intermediate data 120b is sent to the second intermediate data control unit 332 of the printer driver 33.

The second intermediate data control unit 332 converts the intermediate data 120b into printer-processable data, according to the control information 121b of the intermediate data 120b. Based on this converted data, the printer overlays the input data 90a shown in FIG. 9A input from the application 31 on the template input data 90b shown in FIG. 9B, thus obtaining the printout result 90c shown in FIG. 9C. Furthermore, after the data is output, the printer records the changed job name “Cost Estimate” included in the control information 121b as a print log.

As described above, in the information processing apparatus according to the third practical example, in addition to identification information for uniquely identifying input data from an application, information such as a character string and an image and corresponding position information can also be specified as the conditions for executing a predetermined process on input data from an application. In some cases, it may not be possible to actually identify input data received from an application, depending on the identification information assigned to input data by the application. Even in such a case, according to the third practical example, it is possible to execute a data-specific process on the input data.

### MODIFICATION EXAMPLE

In the above-described embodiments of the present invention, the present invention is realized by a program stored in a memory such as the hard disk drive (HDD) in the information processing apparatus or a read-only memory (ROM). However, the present invention can also be realized by hardware in the information processing apparatus.

In the above-described embodiments of the present invention, the printer driver is described as an example of the device driver. However, the present invention can also be applied to any other device driver such as a scanner driver or a PC-FAX driver, as long as it includes software for converting an instruction from an application into data that is processable by a device.

In the embodiments of the present invention, the formats of the device driver and the module conforming thereto are not limited; the present invention can be applied to the application itself.

In an information processing apparatus according to a modification example of the present invention, one or more information items can be specified as the detection information. In this case, the user selects plural character strings from the list 61 of the detection information setting screen 60 shown in FIG. 6, as the detection information.

The present invention is not limited to the specifically disclosed embodiment, and variations and modifications may be made without departing from the scope of the present invention.

The present application is based on Japanese Priority Patent Application No. 2006-158705, filed on Jun. 7, 2006, the entire contents of which are hereby incorporated by reference.

What is claimed is:

1. An information processing apparatus for converting input data into device-processable data that is processable by a device connected via a network, the information processing apparatus comprising:
a process setting registration unit configured to hold in advance therein a predetermined information item included in the input data and a predetermined position information item corresponding to the predetermined information item, the predetermined information item and the predetermined position information item being held in association with a predetermined process that is to be executed to process the input data;
an information control unit configured to
extract, from the input data, plural information items and position information items corresponding to the information items, and
construct control information that specifies a process to be executed to process the input data by the device based on the predetermined process, wherein the control information is constructed in the event that the extracted information items and the extracted position information items include an information item and a position information item that respectively correspond to the predetermined information item and the predetermined position information item held by the process setting registration unit; and
a data converting unit configured to convert the input data into the device-processable data based on the control information constructed by the information control unit.

2. The information processing apparatus according to claim 1, further comprising:
a detection information designating unit configured to designate, as the predetermined information item, at least one information item from among the information items extracted from the input data by the information control unit; and
a process content specifying unit configured to specify the predetermined process that is to be executed to process the input data in the event that the input data includes the predetermined information item designated by the detection information designating unit.

3. The information processing apparatus according to claim 1, wherein
the input data comprises at least portrayal information,
the data converting unit further comprises
a first intermediate data control unit configured to construct intermediate data from the input data, wherein the intermediate data is in a format independent of the device, and
a second intermediate data control unit configured to construct the device-processable data based on the intermediate data, and
the information control unit
extracts, from the intermediate data, the plural information items and the position information items corresponding to the information items,
constructs the control information in the event that the extracted information items and the extracted position information items include an information item and a position information item that respectively correspond to the predetermined information item and the predetermined position information item held by the process setting registration unit, and
outputs the control information together with the portrayal information to the second intermediate data control unit.

4. The information processing apparatus according to claim 1, wherein
the process setting registration unit holds in advance therein, in association with the predetermined information item, predetermined identification information for uniquely identifying the input data, and
the information control unit extracts identification information from the input data and constructs the control information based on the predetermined process, wherein the control information is constructed in the event that the extracted identification information corresponds to the predetermined identification information held by the process setting registration unit.

5. The information processing apparatus according to claim 4, wherein
the input data comprises at least portrayal information,
the data converting unit further comprises
a first intermediate data control unit configured to construct intermediate data from the input data, wherein the intermediate data is in a format independent of the device, and
a second intermediate data control unit configured to construct the device-processable data based on the intermediate data, and
the information control unit
extracts, from the intermediate data, the identification information,
constructs the control information in the event that the extracted identification information corresponds to the predetermined identification information held by the process setting registration unit, and
outputs the control information together with the portrayal information to the second intermediate data control unit.

6. An information processing apparatus for converting input data into device-processable data that is processable by a device connected via a network, the information processing apparatus comprising:
a process setting registration unit configured to hold in advance therein predetermined identification information for uniquely identifying the input data, the predetermined identification information being held in association with a predetermined process that is to be executed to process the input data;
an information control unit configured to
extract identification information from the input data, and
construct control information that specifies a process to be executed to process the input data by the device based on the predetermined process, wherein the control information is constructed in the event that the extracted identification information corresponds to the predetermined identification information held by the process setting registration unit; and
a data converting unit configured to convert the input data into the device-processable data based on the control information constructed by the information control unit.

7. The information processing apparatus according to claim 6, wherein
the input data comprises at least portrayal information,
the data converting unit further comprises
a first intermediate data control unit configured to construct intermediate data from the input data, wherein the intermediate data is in a format independent of the device, and
a second intermediate data control unit configured to construct the device-processable data based on the intermediate data, and
the information control unit
extracts the identification information from the intermediate data,
constructs the control information in the event that the extracted identification information corresponds to the predetermined identification information held by the process setting registration unit, and
outputs the control information together with the portrayal information to the second intermediate data control unit.

8. The information processing apparatus according to claim 6, wherein
the process setting registration unit holds in advance therein, in association with the predetermined identification information, a predetermined information item included in the input data and a predetermined position information item corresponding to the predetermined information item, and
the information control unit extracts, from the input data, plural information items and position information items corresponding to the information items, and constructs the control information based on the predetermined process, wherein the control information is constructed in the event that the extracted information items and the extracted position information items include an information item and a position information item that respectively correspond to the predetermined information item and the predetermined position information item held by the process setting registration unit.

9. The information processing apparatus according to claim 8, further comprising:
a detection information designating unit configured to designate, as the predetermined information item, at least one information item from among the information items extracted from the input data by the information control unit; and
a process content specifying unit configured to specify the predetermined process that is to be executed to process the input data in the event that the input data includes the predetermined information item designated by the detection information designating unit.

10. The information processing apparatus according to claim 9, wherein
the input data comprises at least portrayal information,
the data converting unit further comprises
a first intermediate data control unit configured to construct intermediate data from the input data, wherein the intermediate data is in a format independent of the device, and
a second intermediate data control unit configured to construct the device-processable data based on the intermediate data, and
the information control unit
extracts, from the intermediate data, the plural information items and the position information items corresponding to the information items,
constructs the control information in the event that the extracted information items and the extracted position information items include an information item and a position information item that respectively correspond to the predetermined information item and the predetermined position information item held by the process setting registration unit, and
outputs the control information together with the portrayal information to the second intermediate data control unit.

11. A recording medium that stores therein a computer-readable program that causes a computer to execute a procedure for converting input data into device-processable data that is processable by a device connected via a network, the procedure comprising the steps of:
(a) holding in advance a predetermined information item included in the input data and a predetermined position information item corresponding to the predetermined information item, the predetermined information item and the predetermined position information item being held in association with a predetermined process that is to be executed to process the input data;
(b) extracting, from the input data, plural information items and position information items corresponding to the information items, and constructing control information that specifies a process to be executed to process the input data by the device based on the predetermined process, wherein the control information is constructed in the event that the extracted information items and the extracted position information items include an information item and a position information item that respectively correspond to the predetermined information item and the predetermined position information item held in advance; and
(c) converting the input data into the device-processable data based on the constructed control information.

12. The recording medium according to claim 11, wherein the procedure further comprises the steps of:
(d) designating, as the predetermined information item, at least one information item from among the information items extracted from the input data; and
(e) specifying the predetermined process that is to be executed to process the input data in the event that the input data includes the designated predetermined information item.

13. The recording medium according to claim 11, wherein
the input data comprises at least portrayal information,
step (c) further comprises the steps of
(c-i) constructing intermediate data from the input data, wherein the intermediate data is in a format independent of the device, and
(c-ii) constructing the device-processable data based on the intermediate data, and
step (b) further comprises the steps of
(b-i) extracting, from the intermediate data, the plural information items and the position information items corresponding to the information items,
(b-ii) constructing the control information in the event that the extracted information items and the extracted position information items include an information item and a position information item that respectively correspond to the predetermined information item and the predetermined position information item held in advance, and
(b-iii) outputting the control information together with the portrayal information so as to be processed at step (c-ii).

14. The recording medium according to claim 11, wherein
step (a) further comprises the step of holding in advance, in association with the predetermined information item, predetermined identification information for uniquely identifying the input data, and
step (b) further comprises the step of extracting identification information from the input data and constructing the control information based on the predetermined process, wherein the control information is constructed in the event that the extracted identification information corresponds to the predetermined identification information held in advance.

15. The recording medium according to claim 14, wherein
the input data comprises at least portrayal information,
step (c) further comprises the steps of
(c-i) constructing intermediate data from the input data, wherein the intermediate data is in a format independent of the device, and
(c-ii) constructing the device-processable data based on the intermediate data, and
step (b) further comprises the steps of
(b-i) extracting, the identification information from the intermediate data,
(b-ii) constructing the control information in the event that the extracted identification information corresponds to the predetermined identification information held in advance, and
(b-iii) outputting the control information together with the portrayal information so as to be processed at step (c-ii).

16. A recording medium that stores therein a computer-readable program that causes a computer to execute a procedure for converting input data into device-processable data that is processable by a device connected via a network, the procedure comprising the steps of:
(a) holding in advance predetermined identification information for uniquely identifying the input data, the predetermined identification information being held in association with a predetermined process that is to be executed to process the input data;
(b) extracting identification information from the input data, and constructing control information that specifies a process to be executed to process the input data by the device based on the predetermined process, wherein the control information is constructed in the event that the extracted identification information corresponds to the predetermined identification information held in advance; and
(c) converting the input data into the device-processable data based on the constructed control information.

17. The recording medium according to claim 16, wherein
the input data comprises at least portrayal information,
step (c) further comprises the steps of
(c-i) constructing intermediate data from the input data, wherein the intermediate data is in a format independent of the device, and
(c-ii) constructing the device-processable data based on the intermediate data, and
step (b) further comprises the steps of
(b-i) extracting the identification information from the intermediate data,
(b-ii) constructing the control information in the event that the extracted identification information corresponds to the predetermined identification information held in advance, and
(b-iii) outputting the control information together with the portrayal information so as to be processed at step (c-ii).

18. The recording medium according to claim 16, wherein
step (a) further comprises the step of holding in advance, in association with the predetermined identification information, a predetermined information item included in the input data and a predetermined position information item corresponding to the predetermined information item, and
step (b) further comprises the step of extracting, from the input data, plural information items and position information items corresponding to the information items, and constructing the control information based on the predetermined process, wherein the control information is constructed in the event that the extracted information items and the extracted position information items include an information item and a position information item that respectively correspond to the predetermined information item and the predetermined position information item held in advance.

19. The recording medium according to claim 18, wherein the procedure further comprises the steps of:
(d) designating, as the predetermined information item, at least one information item from among the information items extracted from the input data; and
(e) specifying the predetermined process that is to be executed to process the input data in the event that the input data includes the designated predetermined information item.

20. The recording medium according to claim 18, wherein
the input data comprises at least portrayal information,
step (c) further comprises the steps of
(c-i) constructing intermediate data from the input data, wherein the intermediate data is in a format independent of the device, and
(c-ii) constructing the device-processable data based on the intermediate data, and
step (b) further comprises the steps of
(b-i) extracting, from the intermediate data, the plural information items and the position information items corresponding to the information items,
(b-ii) constructing the control information in the event that the extracted information items and the extracted position information items include an information item and a position information item that respectively correspond to the predetermined information item and the predetermined position information item held in advance, and
(b-iii) outputting the control information together with the portrayal information so as to be processed at step (c-ii).
